(19) United States
(12) Patent Application Publication
(10) Pub. No.: US 2010/0145855 A1
(43) Pub. Date: Jun. 10, 2010

(54) PAYMENT ACCOUNT PROCESSING WHICH CONVEYS NON PURCHASE RELATED DATA EXCHANGES

(76) Inventors: Edward W. Fordyce, III, Sedalia, CO (US); Barbara Elizabeth Patterson, South San Francisco, CA (US)

Correspondence Address: Quarles & Brady LLP, TWO NORTH CENTRAL AVENUE, One Renaissance Square, PHOENIX, AZ, 85004-2391, US

(21) Appl. No.: 12/630,702

(22) Filed: Dec. 3, 2009

Related U.S. Application Data
(60) Provisional application No. 61/120,429, filed on Dec. 6, 2008.

(51) Int. Cl. G06Q 40/00; G06Q 20/00

(52) U.S. Cl. 705/44; 705/39

(57) ABSTRACT

An enhanced payment processing system is configured to process non-sales related requests. For example, such requests may pertain to a consumer's application for a payment account, a request for identification of a payment account assigned to a specified consumer, a transfer of a monetary amount between two payment accounts, a payment to be applied to an account, and a change of an expiration date for a portable payment device. A merchant formulates a non-sales related request which is sent through the payment processing system to an account issuer. The account issuer receives the non-sales related request, complies with that request, and formulates a reply. The reply is sent back through the payment processing system to the merchant.

### CROSS-REFERENCE TO RELATED APPLICATIONS

This application claims priority to, and the benefit of U.S. Provisional Application No. 61/120,429, titled “Payment Account Processing Which Conveys Non-Purchase Related Data Exchanges,” filed Dec. 6, 2008, which is incorporated herein by reference.

### FIELD

The present invention generally relates to exchanging data within a payment processing system, such as one for processing credit and debit card transactions; and more particularly to a merchant performing non-sales related data exchanges via the payment processing system with an issuer of an account. Such non-sales related data exchanges may include processing a credit application, processing a customer's account payment, and obtaining a customer's account number, for example.

### BACKGROUND

It is typical for a particular store to have a spend-and-get incentive program in which program cards are given to consumers. Each time a consumer makes a purchase at that store, either any purchase or the purchase of a specific product, a salesperson punches a hole in the card. After a given number of holes have been punched, the card can be redeemed for a reward, such as a free product. This type of incentive program requires that the consumer bring the card into the store each time a purchase is made and requires that the consumer remembers to present the card to the salesperson. In addition, this program is limited to a particular store or a chain of stores.

Exemplary spend-and-get incentive programs are disclosed in US Patent Application Publication Number 20090006203, published Jan. 1, 2009, and U.S. Provisional Patent Application No. 60/915,079, filed Apr. 30, 2007, both of which are incorporated herein by reference.

A punch card incentive program is not easily implemented when the manufacturer of a product desires to reward consumers who buy a given quantity of that product regardless of the store or stores at which the purchases occur. For that type of reward the consumer usually has to remove a proof of purchase indicium from each product and mail the indicia along with a redemption form to the manufacturer or a clearing house representing the manufacturer. Several weeks later, the consumer then receives in the mail a reward, such as merchandise, a rebate bank check, or a rebate coupon. A rebate coupon must be taken to a store for redemption.

Consumers often pay merchants for goods and services using a payment card account associated with a payment processing system, such as a system operated by Visa®. For example, the account may be part of a credit card program, a debit card program, a flexible spending account (FSA) program, a commercial card program having predetermined goods or services for which the account can be used, and/or a loyalty program which may have a credit limit and other use restrictions. These processing systems handle transactions occurring at a large number of merchants located around the world.

The transaction with a merchant begins with the consumer presenting account information, such as a credit card account number, to the merchant to initiate payment for a product or service. The merchant communicates with the payment processing system to exchange transaction data, such as the account number, merchant identification code, and transaction value, in order to have the payment card transaction authorized, cleared, and settled. The data are exchanged over a communication network in a message that has a predefined format.

Some account holders in these payment processing systems were rewarded based on the monetary amounts of their purchases. For example, for every dollar spent, an account holder received points redeemable for airline tickets and other goods and services. Other account holders received a percentage of the aggregate purchase amounts as a rebate credit to the account. Nevertheless, conventional payment processing systems heretofore were not easily adaptable for spend-and-get incentive programs involving unaffiliated stores and specific name brand products.

Heretofore the types of transactions that a merchant was able to perform via the payment processing system were limited primarily to those related to payment for the purchase of products and services. If a merchant was permitted to receive a credit account application from a customer, that application was sent in paper form to a financial institution that could issue the credit account. Even for a customer with excellent credit, that process took days. Also an existing credit accountholder wanting to make a payment toward that account traditionally had to mail the payment to the account issuer. If the accountholder had another account, such as a checking or savings account with the credit account issuer, a payment could be made by transferring funds between accounts by the accountholder directly contacting the issuer. In any event, an account payment could not be made through a merchant.

There is a desire to enable a merchant to perform enhanced account transactions for a customer, beyond functions related to a purchase transaction.

### SUMMARY

A payment processing system enables a transaction expediter to process a plurality of sales transactions, each characterized by a consumer and a merchant engaging in a sales transaction upon an account that was provided to the consumer by an issuer. A computer-implemented method comprises a merchant formulating a non-sales related request, which then is sent through the payment processing system. The transaction expediter conveys the non-sales related request to an issuer. That issuer receives the non-sales related request, complies with that request, and prepares a reply. The transaction expediter receives the reply and sends a responsive message through the payment processing system to the merchant.

This method is particularly adapted for non-sales related requests that pertain to an application from a consumer for an account, a request for identification of an account assigned to a designated consumer, transferring a monetary amount between first and second accounts, a payment to be applied to an account, or changing an expiration date of a portable payment device, for example.

Another aspect of the present invention requires that each transaction for a given account complies with at least one non-monetary, non-temporal restriction. Here a method implemented by the payment processing system defines at least one such restriction for the given account. Examples of such restrictions include, but are not limited to, use of the given account with only one or more specified merchants, within a geographical territory, or to purchase only certain types of products and services. Alternatively, the given account may be limited to only paying for goods and/or services, for example. As yet another exemplary restriction, use of the given account may be limited to one or a combination of face-to-face transactions, electronic commerce transactions, transactions in which a portable payment device must be shown to the merchant, and telephonic transactions.

When the payment processing system processes a transaction involving the given account, a determination is made whether that transaction conforms with the set of restrictions. If so, the transaction is approved; otherwise the transaction is rejected.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block level diagram illustrating an exemplary payment processing system;

FIG. 2 is a representation of a point of sale terminal that is part of a merchant in the payment processing system;

FIG. 3 depicts an exemplary transaction data matching system, wherein a processor matches non-financial and financial transaction data;

FIG. 4 illustrates an exemplary transaction data matching system wherein another system component matches the non-financial and financial transaction data;

FIG. 5 shows an exemplary transaction data matching implementation, wherein the non-financial and financial transaction data processing utilizes a transaction data repository;

FIG. 6 depicts an alternative implementation that employs a transaction data repository;

FIG. 7 illustrates an exemplary process by which a merchant looks up an existing account number at an issuer;

FIG. 8 depicts an exemplary process by which a merchant looks up an account balance at an issuer;

FIG. 9 shows processing of an exemplary request for account information regarding a particular consumer;

FIG. 10 is an exemplary instant payment card application process utilizing the authorization structure within the payment processing system;

FIGS. 11A and 11B show two processes by which a merchant transfers a balance of one payment account to another payment account;

FIG. 12 illustrates an exemplary procedure by which a merchant accepts a payment that is to be applied to an portable payment device account at an issuer;

FIG. 13 represents a procedure by which a merchant obtains an extension of the expiration date of a portable payment device;

FIG. 14 depicts a limited acceptance function by which transactions using a portable payment device are limited based on one or more defined restrictions; and

FIG. 15 is a table of exemplary restrictions for the limited acceptance function.

### DESCRIPTION

The present concept has particular application to processing data related to an incentive program that offers rewards to consumers who use a portable payment device to purchase specific products or services as defined by program rules. A given incentive program may be sponsored by a merchant, such as a store chain, a manufacturer or distributor of a brand of products, or an issuer of the portable payment device. For example, a loyalty type incentive program may have a spend-and-get rule, wherein the tenth purchase of a particular product results in the eleventh purchase of that product being free. To illustrate, Walgreens® retail stores may have a nationwide spend-and-get promotion which encourages a consumer to use a particular type of credit card to purchase Orville Redenbacher's® popcorn. The credit card is a co-branded Walgreens®—Wells Fargo® Bank credit card. When a consumer uses that type of credit card to make the eleventh purchase of Orville Redenbacher's® popcorn, the Walgreens® store either does not charge the consumer for the purchase or the consumer receives a credit for the price of the popcorn on his or her credit card statement.

Other incentive programs are offered to only select consumers, such as those spending more than a certain amount each month. Those consumers may be eligible for a given amount (e.g. $10.00 US) off a purchase that exceeds a predefined amount (e.g. $100.00 US). Another incentive program may inform selected consumers that, if they purchase a particular item, such as a mattress, they will receive another item, such as a bed spread, free. These various incentive programs have specific rules that must be satisfied before a consumer can get the reward. Examples of such rules are a list or people to whom the program is available, the consumer has to purchase a particular product or a given quantity of a particular product, or the consumer must use a specific type of portable payment device.

First Payment Processing System Implementation

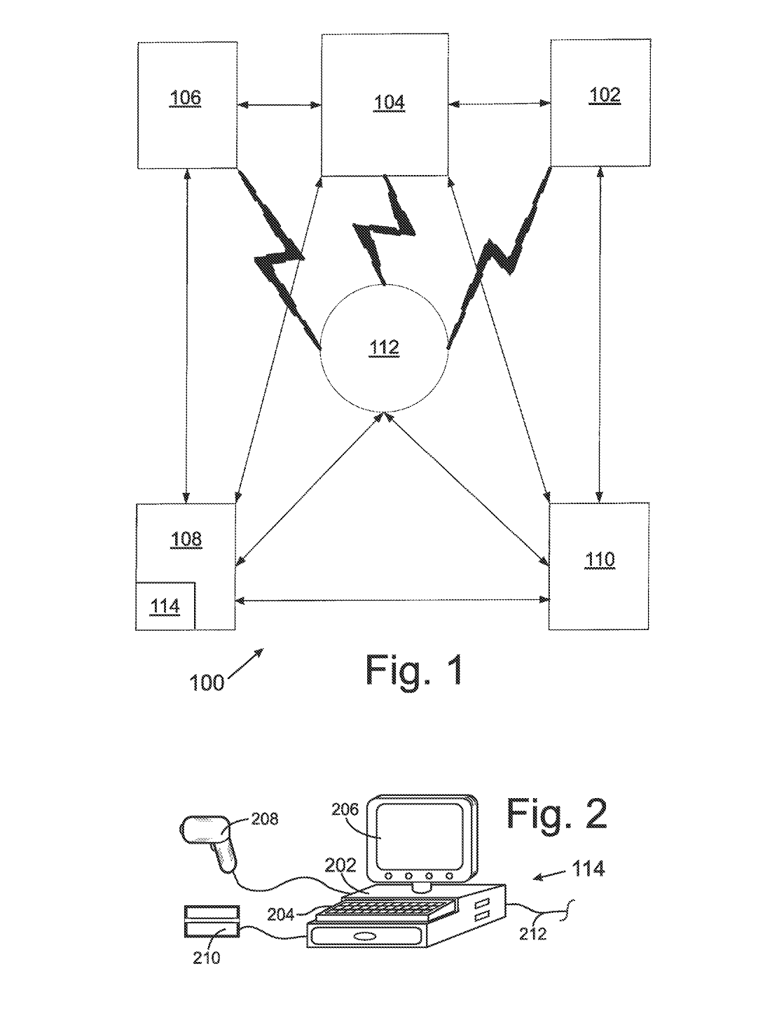

FIG. 1 depicts a first payment processing system 100 for processing a financial transaction that involves participation from different entities and which has been enhanced to process data for an incentive program. The first payment processing system 100 includes an issuer 102, a transaction handler 104, an acquirer 106, a merchant 108, and a consumer 110, such as an account holder. The merchant 108 may be a person or business that sells goods or services, for instance a retailer, a manufacturer, a wholesale distributor, a restaurant, or a medical facility. In a business-to-business setting, the consumer 110 may be another merchant making a purchase from the merchant 108. Therefore, a consumer or account holder includes any person or entity with an account and/or a payment device associated with an account, where the account is within a payment system. The acquirer 106 and the issuer 102 can be different entities or the same entity, but in either case the financial transaction is processed through the transaction handler 104. The issuer 102 is an entity that issued a payment account and/or a portable payment device 112, such as a credit or debit card, to the consumer 110. The issuer 102 may be a bank or other financial institution or it may be another type of entity such as a department store that issues private label accounts that are usable only at that entity. The acquirer 106, also typically is a bank or other financial institution, that has a payment processing agreement with the merchant 108. The transaction handler 104 may be a credit card company, such as Visa®. It should be understood that the transaction handler 104 is connected to a large number of acquirers and issuers and handles the exchange of financial transaction data among them. For some merchants, the acquirer and the transaction handler may be the same entity.

Payment processing systems of this type are used to clear and settle purchase transactions that are made using a portable payment device. Clearing includes the exchange of financial information between the issuer 102 and the acquirer 106, and settlement comprises the exchange of funds.

Often, a transaction begins with the consumer 110 contacting the merchant to acquire a product or service. For example in a retail store, the consumer places one or more products on a counter adjacent a point of sale (POS) terminal 114, such as a cash register. With reference to FIG. 2, an exemplary point of sale (POS) terminal 114 comprises a processing unit 202 to which a keyboard 204, a computer display 206, a optical scanner 208 for merchandise, and a payment device scanner 210 are connected. The processing unit 202 is connected to the acquirer 106 by a communication link, such as a telephone line or the Internet. Other types of point of sale terminals include a cellular phone, personal digital assistant (PDA), personal computer, tablet computer, handheld specialized reader, set-top box, electronic cash register (ECR), automated teller machine (ATM), virtual cash register (VCR), kiosk, security system, or access system.

Then an employee of the merchant uses the optical scanner 208 to read a product identifier, such as a Stock Keeping Unit (SKU) number, Universal Product Code (UPC) number and the like, on the package of each product. In other situations, the employee types the product or service identifier into a keyboard 204. As used herein, the term “product” includes a service or a product, and a “product identifier” may identify a service or a product. The product identifiers enable the point of sale terminal 114 to query a storage device to obtain the price of each product and calculate the total amount of the purchase.

Then the consumer 110 presents a portable payment device 112 to merchant 108 to pay for purchasing the product or service. As used herein, the portable payment device 112 can be a payment card, a gift card, a smartcard, a smart media, a payroll card, a health care card, a wrist band, a machine readable medium containing account information, a keychain device such as a SPEEDPASS® device commercially available from ExxonMobil Corporation or a supermarket discount card, a cellular phone, personal digital assistant (PDA), a pager, a security card, an access card, a substrate bearing an optically scanable data region, a wireless terminal, or a transponder. The portable payment device 112 may include a volatile or non-volatile memory to store information such as the account number or an account holder's name. The term “portable payment device” as used herein does not include money and checks.

The point of sale terminal 114 obtains account information, such as an account number and account holder's name, from the portable payment device 112. The portable payment device 112 interfaces with the point of sale terminal 114 using the payment device scanner 210 that employs any suitable electrical, magnetic, or optical mechanism. In addition to the account information read from the portable payment device 112, the point of sale terminal 114 also generates other financial transaction data, including the monetary amount of the purchase, tax amount, date and time of transaction, the identity of the merchant, and a transaction identification code. The transaction identification code may be an alphanumerical code, characters (e.g., Chinese character), symbols (e.g., §), a hashed value, or combinations thereof. The transaction identification code may be randomly assigned to each new transaction or the transaction identification code may reflect characteristics of the transaction such as time, date, merchant identification code, location of merchant, or combinations appended together (e.g., 10311968555-Oct. 31, 1968 and merchant code 555).

The merchant 108 utilizes the point of sale terminal 114 to communicate the transaction data to the acquirer 106, the transaction handler 104, or the issuer 102. All the financial transaction data related to payment for the products or services and the non-financial transaction data identifying the products to services are incorporated by the point of sale terminal 114 into a transaction authorization request. Then the transaction authorization request is sent as a single message to the acquirer 106 which then is sent from the merchant 108 to the acquirer 106 associated with that merchant. The acquirer 106 forwards the transaction authorization request to the transaction handler 104 which determines the issuer 102 from a portion of the account number. The transaction handler 104 then sends the transaction authorization request to the issuer 102 of the portable payment device 112.

Upon receiving the financial transaction data, the issuer 102 uses business rules to determine whether to approve or decline the transaction authorization request. The business rules are instructions or guidelines that specify conditions, such as the consumer not exceeding a credit limit, which must be satisfied in order for the request to be approved. The business rules can be set by the consumer 110, the merchant 108, the acquirer 106, the issuer 102, the transaction handler 104, another financial institution, or combinations thereof. After making the approval determination, the issuer 102 sends a reply message through transaction handler 104 and the acquirer 106 to the merchant 108 indicating approval or rejection of the transaction authorization request. Alternatively, the transaction handler 104 may authorize, or clear, the purchase transaction. In either situation, the transaction handler 104 may maintain a log or history of approved transaction authorization requests. Upon receiving a reply message approving the transaction authorization request, the merchant 108 records the approval and delivers the product or service to the consumer 110.

The merchant 108 may, at discrete periods, such as the end of the day, submit a list of authorized transactions to the acquirer 106 or other components of the first payment processing system 100 for settlement. The transaction handler 104 may compare the submitted authorized transaction list with its own log of authorized transactions. If a match is found, the transaction handler 104 routes authorization transaction amount requests from the corresponding acquirer 106 to the corresponding issuer 102 involved in each transaction. Upon receiving payment of the authorized transaction amount from the issuer 102, the acquirer 106 forwards the payment to merchant 108 after deducting any transaction costs and fees. If the transaction involves a debit or pre-paid card, the acquirer 106 may choose not to wait until payment is received before to paying the merchant 108.

There may be intermediate steps in the foregoing process, some of which may occur simultaneously. For example, the acquirer 106 can initiate the clearing and settlement process, which results in payment to the acquirer 106 for the amount of the transaction. The acquirer 106 may request from the transaction handler 104 that the transaction be cleared and settled.

The transaction handler 104 can provide services in connection with settlement of the transaction, i.e. the exchange of funds. The settlement of a transaction involves the issuer 102 depositing an amount of the transaction settlement from a first clearinghouse, such as a bank, which the issuer 102 typically chooses, into a settlement house, such as a settlement bank, typically chosen by the transaction handler 104. Then the amount of the transaction settlement is transferred from the settlement house into a second clearinghouse, such as a bank that the acquirer 106 typically chooses, from which the amount is deposited into the merchant's account. Thus, a typical transaction involves numerous entities to request, authorize, and fulfill processing the transaction.

The present concept involves transmitting financial transaction data and non-financial transaction data through a payment processing system and can be performed by one of several Implementations. Financial transaction data is defined as the data related to the payment for goods and services and non-financial transaction data is other data than that which is required for the payment for goods and services. For example, the non-financial transaction data may be required by an product purchase incentive program, or data unrelated to product purchases, for example, patient record data sent between medical facilities.

The previously described functions for payment of commerce transactions that involve a portable payment device are exemplary of prior payment processing systems. However, the first payment processing system 100 further includes novel enhanced authorization functionality which enables non-financial transaction data to be processed by the payment processing systems. The non-financial transaction data may be related to incentive programs that encourage consumers to purchase certain products or services for which rewards will be issued. Either the transaction handler 104 or the issuer 102 can be configured to process the financial and non-financial transaction data to determine whether the consumer is participating in an established incentive program and if so, whether the present purchase is applicable to that program. That configured entity is referred to as the “program processor.” These determinations are based on program rules defined by the entity that is operating the incentive program, wherein those program rules are stored in the processing computers at the program processor, the transaction handler 104 or the issuer 102. The program processor applied the program rules to the financial and non-financial transaction data for the transactions, and updates the consumer's incentive program file accordingly. For example, if the present transaction indicates that the consumer is purchasing a package of Orville Redenbacher's® popcorn with a co-branded Walgreens®—Wells Fargo® Visa credit card, then a count in the incentive program file of the number of such packages that this consumer has purchased is incremented by the number of packages in the present transaction. The product identifiers in the non-financial transaction data portion of the transaction authorization request message are used to identify the purchase of Orville Redenbacher's® popcorn and the account number specifies the type of portable payment device that was used.

When the present transaction is part of an incentive program, the program rules also are reviewed by the program processor to determine whether the consumer now qualifies for a reward, for example whether ten packages of Orville Redenbacher's® popcorn now have been purchased entitling the consumer to a free package of popcorn. If qualifying for a reward, the data in the consumer's incentive program file is changed to indicate that reward. In the exemplary program, an indication is placed in the consumer's incentive program file that the next package of Orville Redenbacher's® popcorn will be free. If the present purchase, qualifies as the free one, a message to that effect may be sent back to the merchant 108, which then can inform the consumer of the free package of popcorn. In this latter instance, the merchant is paid for the value of the free package of popcorn, but either the consumer's payment device account is not charged for that item or if charged, the account also is credited for the value of the free package of popcorn. The program processor then charges the value of the package of popcorn and any incentive program operating fees to an account for the sponsor of the incentive program (e.g., ConAgra Foods, Inc which produces Orville Redenbacher's® popcorn).

In other incentive programs, a message may be transmitted back through the payment processing system 100 to the merchant 108 indicating that this consumer is entitled to a reward directly from the merchant, such as a free bedspread to accompany a mattress purchase. The salesperson at the merchant then dispenses the designated reward.

In the first payment processing system implementation just described, the financial and non-financial transaction data were transmitted through the first payment processing system 100 in the same message. This may not be easily accomplished in an existing financial processing system in which the structure of the message for the financial transaction data has been standardized and cannot be modified for the non-financial transaction data without considerable alteration of the system. Therefore, the financial and non-financial transaction data must be sent in two separate messages in many systems, however a mechanism then has to be provided to match the two messages for the same transaction in order to obtain all the data needed by the incentive program processor.

For example, the merchant may send a first message having the previously defined format that contains the financial transaction data necessary for payment of the purchase. The financial transaction data includes the consumer's account number, the purchase monetary amount, sales tax, and a transaction identification code for the purchase transaction. The transaction identification code may be an alphanumerical code, characters (e.g., Chinese characters), symbols (e.g., &, #, §), a hashed value, or combinations thereof. The transaction identification code may be randomly assigned to each new transaction or the transaction identification code may reflect characteristics of the transaction such as time, date, merchant identification code, location of merchant, or combinations appended together (e.g., 10311968555-Oct. 31, 1968 and merchant code 555). Assume for the present purchase example that the transaction identification code is “AAA123”. The second message with the non-financial transaction data also contains the account number and the same transaction identification code (e.g. “AAA123”). In addition, the second message contains data required for the incentive program, such as the product identifier (e.g. SKU or UPC number) for each product being purchased or at least for any purchased products related to any one of the incentive programs that may be in effect at the time of the purchase.

Even with two messages some components of an existing financial processing system may not be capable of handling a message with a product identifier, thus requiring an alternative message transmission path for the non-financial transaction data. As a result, one of several processing system implementations can be utilized.

Second Payment Processing System Implementation

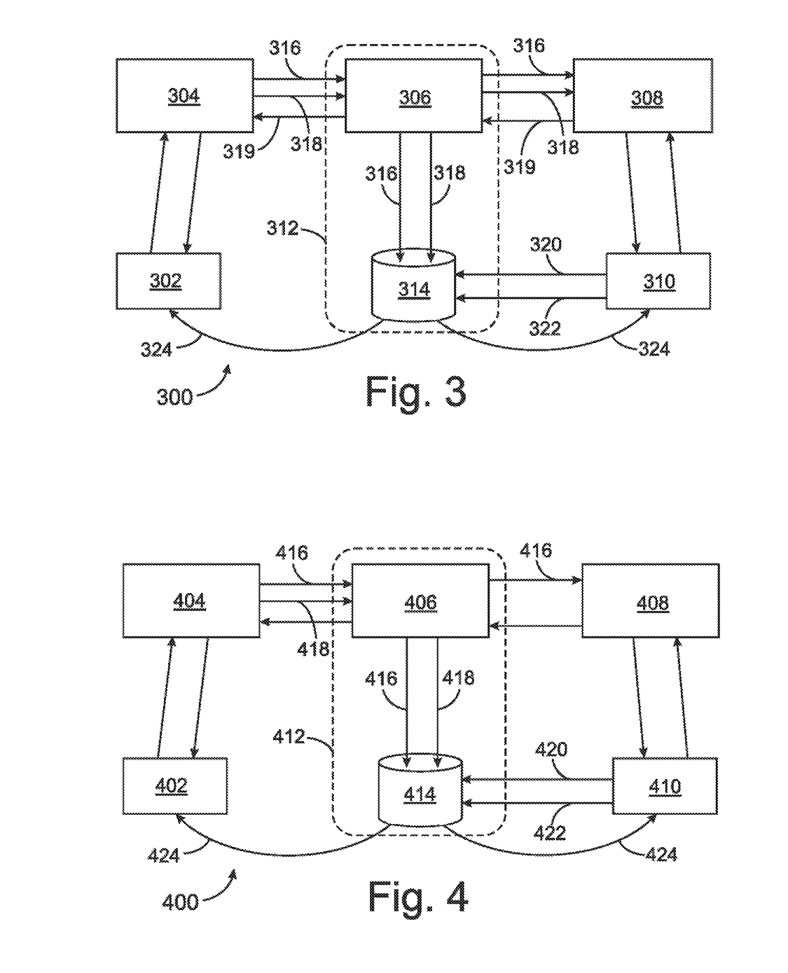

With reference to FIG. 3, a second payment processing system 300 comprises a merchant 302, an acquirer 304, a transaction handler 306, a transaction processor 308, and an issuer 310 of a portable payment device. The transaction processor 308 is a component that processes payment transactions for the issuer 310 and may be part of the same financial institution as the issuer or may be a separate entity under contract with the issuer. The transaction handler 306 is part of a transaction expediter 312, that also includes a qualifier 314. The qualifier 314 has several functions, which include acting as the program processor by determining whether an active incentive program applies to a particular purchase and if so, applies the rules of that program to the purchase, as will be described. Alternatively the qualifier 314 could be a separate entity from the transaction expediter 312 which functions as the transaction handler 306.

When the consumer makes a purchase and presents a portable payment device, the merchant processes that transaction as described above for the first payment processing system implementation and sends the financial and non-financial transaction data to the associated acquirer 304. That transmission of that data may be in a single or multiple messages. The acquirer 304 reformats the data into two separate messages. The first message 316 is in the form of a conventional transaction authorization request that contains the standard financial transaction data related to processing payment for the purchase, and the second message 318 contains the non-financial transaction data related to the items that have been purchased. The merchant may send the product identifier that is a Stock Keeping Unit (SKU) number or other identifier which is unique to that specific merchant. In that case, the acquirer 304 has a table that relates the merchant specific product identifier to a standardized product identifier, such as the Universal Product Code (UPC) number, for the payment processing system. That standardized product identifier then is inserted into the second message 318. Alternatively the translation of the merchant specific product identifier into a standardized product identifier can be performed by the transaction handler 306, especially for a merchant that has a large number of stores nationwide that utilize a plurality of acquirers.

The acquirer 304 then transmits the first and second messages 316 and 318 to the transaction handler 306. Note that either the first message or the second message may be sent first and the designations of first and second herein do not indicate the order of transmission. In addition, the first message with the payment related financial transaction data may be sent in real time, while the second message containing the non-financial for the same transaction may be aggregated with similar data for other transactions and sent in batch form. The arrows labeled 316 and 318 in FIG. 3 denote the first and second messages, respectively, traveling through the second payment processing system 300.

The transaction handler 306 receives the first and second messages 316 and 318 from the acquirer 304 and functions as a communication facilitator. In that capacity, the transaction handler 306 analyzes a portion of the account number to determine which of the numerous issuers in the worldwide second payment processing system 300 is associated with that payment account. The transaction handler 306 then sends the first and second messages 316 and 318 to the qualifier 314 and to the transaction processor 308. The transaction handler 306 may add other data to those forwarded in the first and second messages 316 and 318.

Understand that the transaction processor 308 is also receiving messages for other financial transactions being handled simultaneously by the transaction handler 306. Therefore, the transaction processor 308 matches the two messages for the same transaction by utilizing various components of the financial or non-financial transaction data. As described above, the transaction identification code can be matched; alternatively the consumer account number, date and time of day, and/or the merchant identification code can be used to distinguish the messages for different transactions and link the first and second messages for each transaction. The message matching links the first message containing the financial transaction data (e.g. the product purchase price) with the second message carrying the non-financial transaction data (e.g. the product identifiers), thereby enabling all the data for the each financial transaction to be brought together for further processing.

The merchant identification code distinguishes both the merchant and the transactions involving the merchant, even if there is a lack of uniformity amongst how a financial institution, such as an acquirer 304, logs transactions and logs the association of the transaction with the incentive program. For example, HD hardware store chain has its own incentive program in connection with the issuer 310. The HD hardware store chain may have two franchisee merchants, “HD hardware store X” and “HD hardware store Y”, each having different acquirers. Acquirer X may keep an internal transaction log for franchisee merchant HD hardware store X with an identifier “9999” and Acquirer Y may keep a separate internal transaction log for HD hardware store Y with an identifier “WQ83.” The single issuer involved in the HD hardware store incentive program may not be able to recognize transaction identifiers “9999” and “WQ83” as associated with HD hardware store chain. Consequently, the issuer may have difficulty determining if purchases at each store qualify for the HD hardware store incentive program. This indistinguishablity is further complicated where HD hardware store X banks at both Acquirer X and Acquirer Y and each of which use different merchant identifiers for that store. On the other hand, if the HD hardware store chain assigns unique franchisee codes to each store, the payment processing system is not reliant on the acquirer merchant identifiers and the issuer is able to better distinguish HD hardware store X or HD hardware store Y as participants of the HD hardware store incentive program.

Alternatively in the case of a store chain, the transaction handler 306 which is used by all the acquirers in the second payment processing system 300, can sent the merchant identification code to distinguish the merchant. For example, the transaction handler 306 maintains a merchant identification code for the McDonald's Corporation. The transaction handler may receive transaction messages containing part of the merchant identification code and use that part to distinguish the merchant corresponding to an incentive program. The transaction processor 308 and/or the qualifier 314 may utilize the merchant identifier code to facilitate matching the financial and non-financial transaction data.

In one version of the second payment processing system 300 in FIG. 3, the transaction processor 308 matches the first and second messages 316 and 318 for the each financial transaction. The transaction processor 308 then forwards an enriched record, containing all the matched financial and non-financial transaction data to the issuer 310. The issuer reviews the financial transaction data to determine whether to authorize or decline the financial transaction. A message 319 authorizing or declining the financial transaction then is sent by the issuer 310 back through the second payment processing system 300 to the merchant 302.

The issuer 310 also may send account holder data 320, merchant data 322, and the matched product identification data to the qualifier 314. The account holder data 320 may include the account number, consumer name, and consumer billing address. The merchant data 322 for example includes data that are applicable to an incentive program such as: the program rules, promotion information, promotion codes, and product identifiers for qualifying goods or services. The qualifier 314, acting as the program processor, utilizes the account holder data, the merchant data, and the matched financial and non-financial transaction data to determine if the consumer should receive the benefit of the incentive program as defined by the associated program rules.

Specifically the qualifier 314 matches the non-financial and financial transaction data received from the transaction handler 306, for example by utilizing the transaction identifier code for the transaction. Then the qualifier 314 uses the account holder data and the merchant data sent from the issuer 310 to determine whether the consumer is eligible to participate in an active incentive program based on the various program rules. Some incentive programs are limited to only specified account holders, e.g. high monetary amount spenders. For those incentive programs a determination is made whether the portable payment device account or the consumer name for the current transaction is on a list of program participants. Other programs are open to all persons using a portable payment device or a certain type of device, e.g. a Nordstrom® store privately branded credit card. In the latter case, the account number in the financial transaction data are checked against the list of types of portable payment devices in the program rules. The qualifier 314 also applies other program rules, such as those that designate particular products that qualify for a reward. The qualifier 314 further determines whether the program rules require that a defined quantity of a particular product needs to be purchased in order to qualify for a reward, and if so increments a count of such products purchased by the account holder and determines whether the qualifying quantity has been reached.

Should the transaction corresponding to the matched transaction data qualify for the incentive program, the qualifier 314 can facilitate the implementation of the program (e.g., facilitate the sending of a free bedspread to consumer that purchased a mattress using a Nordstrom® privately branded credit card).

The qualifier 314 also transmits transaction and/or processing fee files 324 related to the incentive program to one or both of: the merchant and the issuer. This notifies the merchant when the customer qualifies for a reward so that the merchant can inform the customer and, if applicable, deliver the reward. The qualifier 314 also may assess a fee for processing the incentive program, wherein a fee may be due from either or both the merchant 302 and the issuer 310. Once the processing fees are determined, messages specifying the fee amounts are sent to the merchant 302 and the issuer 310 as is appropriate. The issuer 310 may true up with the merchant 302 offline for those fees.

Third Payment Processing System Implementation

Referring to FIG. 4, an exemplary third payment processing system 400 is depicted that comprises a merchant 402, an acquirer 404, a transaction handler 406, a transaction processor 408, an issuer 410 and a qualifier 414. The transaction handler 406 and the qualifier 414 preferably are part of a transaction expediter 412. In this implementation, the transaction processor 408 does not match non-financial and financial transaction data in the first and second messages 416 and 418. Instead, only the qualifier 414 performs that data matching, as part of functioning as the program processor.

A consumer having an account within the third payment processing system 400 and being associated with an incentive program goes to the merchant 402 to make a purchase. The merchant 402 sends the merchant's acquirer 404 financial and non-financial transaction data corresponding to a purchase transaction. For example, the merchant may populate fields in a transaction message with payment related data and incentive program data.

Typically the acquirer 404 parses the financial and non-financial transaction data and reformats that data into the defined first and second messages 416 and 418, which are sent to the transaction handler 406. The transaction handler 406 forwards both the first message 416 containing the financial transaction data and the second message 418 containing the non-financial transaction data to the qualifier 414. Only the first message 416 with the standard financial transaction data associated with payment authorization is sent by the transaction handler 406 to the transaction processor 408. Therefore, the transaction processor 408 does not receive the non-financial transaction data associated with the incentive program. For example, the transaction processor 408 may lack the capability to receive the product identifiers or may not have the capability to match the financial and the non-financial transaction data in first and second messages 416 and 418.

The transaction processor 408 forwards the financial transaction data to the issuer 401 which processes the request in that data for payment authorization and sends a corresponding message back to the acquirer 404. In addition, the issuer 401 responds by sending a message that contains the respective transaction identifier code, account holder data 420, and merchant data 422 to the qualifier 414. The account holder data 420 include the account number associated with the portable payment device that was used at the merchant 402, the consumer's name, and the consumer billing address. The merchant data 422 include information related to the applicable incentive program, such as: the program rules, promotion information, promotion codes, and the product identifiers for eligible goods and services.

The qualifier 414, acting as the program processor, matches the non-financial and financial transaction data received from the transaction handler 406 by utilizing the transaction identifier code in the associated first and second messages 416 and 418. Then the qualifier 414 uses the account holder data 420 and the merchant data 422 received from the issuer 410 to determine whether the consumer is eligible to participate in an active incentive program based on the program rules. This reward qualification process is the same as used by the qualifier 414 in the second payment processing system 400 described previously. The qualifier 414 then sends messages 424 informing the merchants 402 and the issuer 410 about the incentive program processing results.

Fourth Payment Processing System Implementation

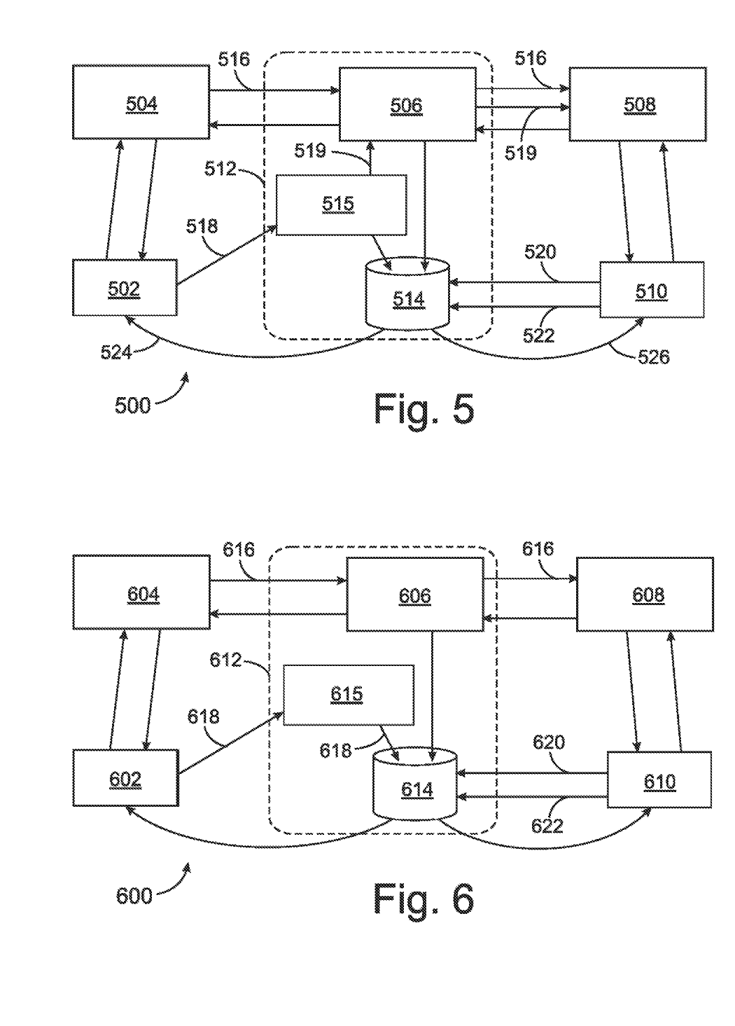

Referring to FIG. 5, an exemplary fourth payment processing system 500 is illustrated that comprises a merchant 502, an acquirer 504, a transaction handler 506, a transaction processor 508, an issuer 510 and a qualifier 514. The transaction handler 506 and the qualifier 514 preferably are part of a transaction expediter 512. In this implementation, the transaction processor 508 and/or the qualifier 514 matches the non-financial and financial transaction data.

A consumer purchases goods or services at the merchant 502 using a portable payment device in the same manner a described with respect to the previous implementations. In this latter implementation, the acquirer 504, however, is unable to process non-financial transaction data, such as data related to an incentive program. As a result, the merchant 502 transmits the traditional financial transaction data, associated with the conventional payment clearing process, to the acquirer 504 which incorporates that data into the standard first message 516. That first message 516 then is sent to the transaction handler 506 which uses the account number in the data to identify the particular issuer 510 for that account. The payment clearing process continues with the first message 516 being forwarded through the transaction handler 506 and the transaction processor 508 to the issuer 510. The issuer 510 authorizes or declines payment of this transaction and notifies the merchant 502 accordingly.

In the fourth payment processing system 500, the merchant 502 formats the second message 518 that contains the transaction's non-financial transaction data associated with the incentive program. The second message 518 is sent to a transaction data repository 515 that receives, stores, and forwards the product identifiers for the respective purchase transaction. For example, the transaction data repository 515 may be a database within the transaction expediter 512 that is accessible by the transaction handler 506. The merchant may send the product identifier as a Stock Keeping Unit (SKU) number or other identifier which is unique to that specific merchant. In that case, the transaction data repository 515 has a table that relates the merchant specific product identifier to the standardized product identifier (e.g., a UPC number) for the payment processing system. The transaction data repository 515 then forwards at least some components 519 of the non-financial transaction data to the transaction handler 506 and/or to the qualifier 514. In response, the transaction handler 506 forwards the components 519 of the non-financial transaction data received from the transaction data repository 515 to the transaction processor 508. Thus the transaction processor 508 receives the financial transaction data in the first message 516 and the components 519 of the non-financial transaction data from the second message 518.

Each of the qualifier 514 and the transaction processor 508 may then match the non-financial transaction data and the financial transaction data for the present transaction. The issuer 510 is notified about the current purchase transaction by the transaction processor 508, which notification includes the account number or other data that enables the issuer to identify the respective account holder.

In response to that notification, the issuer 510 sends account holder data 520 and merchant data 522, and optionally the non-financial transaction data and the financial transaction data matched by the processor, to the qualifier 514. The account holder data 520 may include the relevant account number, consumer name, and consumer billing address. The merchant data 522 include information applicable to the incentive program such as: the program rules, promotion information, promotion codes, and identifiers for the products involved in that incentive program. If the issuer 510 sends the qualifier 514 the financial transaction data and the non-financial transaction data matched by the transaction processor 508, the qualifier 514 may check that matched data against the qualifier's matched financial and non-financial transaction data for errors and/or match confirmation.

As described in detail for the previous implementations, the qualifier 514 then utilizes the account holder data 520, the merchant data 522, and the matched financial and non-financial transaction data to determine whether the consumer is entitled to receive the benefits of the incentive program as defined by the program rules. Should the transaction qualify for the incentive program, the qualifier 514 facilitates the implementation of the program by issuing a reward to the consumer. Such reward issuance can involve mailing a reward item (e.g. a bedspread directly to the consumer), sending a message 524 through the fourth payment processing system 500 instructing the merchant 502 for the current transaction to deliver the reward, such as an item of merchandise or a price discount, to the consumer, or send a different message 526 instructing the issuer 510 to deliver the reward. A reward includes any discount, credit, product, service, package, event, experience (such as wine tasting, dining, travel), or any similar item of value.

The qualifier 514 also transmits transaction and/or incentive program processing fee messages 524 to one or both of the merchant 502 and the issuer 510. The issuer 510 may true up with the merchant 502 offline for fees.

Fifth Payment Processing System Implementation

With reference to FIG. 6, an exemplary fifth payment processing system 600 is illustrated that comprises a merchant 602, an acquirer 604, a transaction handler 606, a transaction processor 608, an issuer 610, a qualifier 614, and a transaction data repository 615. The transaction handler 606, the qualifier 614, and the transaction data repository 615 preferably are part of a transaction expediter 612, but one or all of them may be separate entities in communication with each other. In this implementation, the transaction processor 608 and/or the qualifier 614 matches the non-financial and financial transaction data.

With this implementation, a consumer uses a portable payment device to purchase a product at a merchant 602 in the same manner as described for the previous implementations. Now the merchant 602 transmits the traditional financial transaction data, associated with the conventional payment clearing process, in a first message 616 to the acquirer 604 which relays the data to the transaction handler 606. The payment clearing process continues with the first message 616 being forwarded through the transaction handler 606 and the transaction processor 608 to the issuer 610. The issuer 610 authorizes or declines payment of this transaction and notifies the merchant 602 of that result.

In this implementation, the acquirer may not be able to process the non-financial transaction data, such as by separating that data from the financial transaction data and sending the separated data in different messages. As a consequence, the merchant 602 formats the second message 618 that contains the transaction's non-financial transaction data necessary for incentive programs. The second message 618 is sent to a transaction data repository 615 that receives, stores, and forwards the product identifiers and other non-financial transaction data for the respective purchase transaction. Unlike the fourth payment processing system 500, however, the transaction data repository 615 does not send the non-financial transaction data to the transaction handler 606; rather the transaction data repository only sends the non-financial transaction data in the second message 618 to the qualifier 614. In this implementation, the qualifier 614 matches the non-financial transaction data and the financial transaction data associated with each purchase transaction. The qualifier 614 also may receive account holder data 620 and merchant data 622, that includes incentive program rules, from the issuer 610.

The qualifier 614 then utilizes the account holder data, the merchant data and the matched financial and non-financial transaction data to determine if the consumer is entitled to receive the benefit of an incentive program as defined by the program rules. Should the transaction corresponding to the matched data qualify for the incentive program, the qualifier 614 then facilitates the delivery of a reward to which the customer is entitled. The qualifier 614 also transmits transaction and/or incentive program processing fee files 624 to one or both of the merchant 602 and the issuer 610. The issuer 610 may true up with the merchant 602 offline for fees.

The second through fifth implementations vary based in part on parameters such as: which transaction processing component sources the non-financial transaction data, which component matches the non-financial transaction data, and whether the processor is required to have the non-financial transaction data, for example. Other combinations of the parameters can be appreciated and understood by those skilled in the relevant art. Variation of an implementation depends on considerations such as: merchant participation level and acquirer capabilities; an impact that time of delivery of the non-financial transaction data has on the matching processes and subsequent information availability; speed to market—some solutions are more easily implemented; and expenses for acquiring and matching the non-financial transaction data. For example, sending the financial transaction data and the non-financial transaction data in the same batch mitigates matching issues, thereby reducing errors.

Enhanced Non-Purchase Related Functions

The payment processing systems described previously were employed to handle transactions involving the purchase of products or services and the payment for those purchases. These prior payment processing systems can be enhanced to provide functions at the merchant that are unrelated to the purchase of products or services, thereby giving merchants and issuers greater flexibility in dealing with consumers. Using an existing payment processing system avoids having to establish an additional business communication channel for these additional functions and provides a highly secure and very reliable communication channel for exchanging data for the non-purchase related transactions. Moreover, many enhanced authorization functions can be provided without making structural changes to an existing payment processing system, such as hardware, software or connection changes.

The enhanced non-purchase related functions can include: processing and approving credit applications, a merchant accepting payment of the balance due on an consumer's account, transferring an account balance from one payment account to another payment account, and renewal of a portable payment device, i.e., extending the expiration date. Enhanced non-purchase related functions can also define messages that carry information between parties through the payment processing system, such as looking up data for an existing account, for example.

Enhanced non-purchase related functions enable any transaction program or product to support limited acceptance based on a variety of processing parameters. Such support may be applicable in authorizing, clearing and settling operations that are limited by defined parameters, for example: merchant commodity code (e.g., code for “apparel”), transaction channel such as face to face transaction or electronic commerce, specified merchants, geographical locations, or a combination of such limiting parameters.

Some non-purchase related functions previously occurred at merchants in a “closed payment system” where the merchant was the issuer or contracted with a company that served as the issuer for the merchant. Examples of a closed payment system are an in-house charge account, for example at the Acme Industrial Supply Company having a single store, or a privately branded credit card for specific store chain, such as Macy's® department stores. Here the merchant or the contractor on behalf of the merchant operated the payment account system. Non-purchase related functions heretofore were not available in an “open payment system” where the merchant is unrelated to the account issuer. Examples of open payment systems include ones that use a generic Visa® credit or debit card, or a co-branded credit card, e.g. a Walgreens®—Wells Fargo® Bank Visa® credit card that can be used at many different merchants.

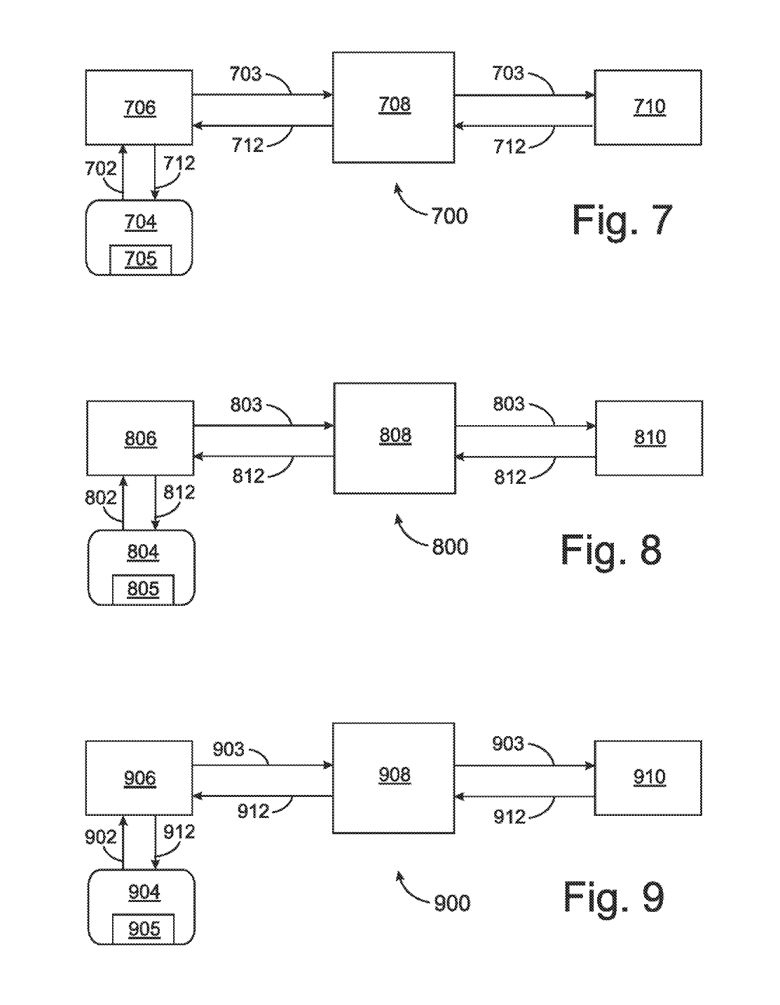

Referring to FIG. 7, a consumer upon reaching the point of sale terminal 705 at a merchant 704 may discover that he or she is not carrying the portable payment device with which to make the purchase. For example, the consumer at a Wal-mart® store may desire to use a privately branded Wal-mart® store credit card. Alternatively, the consumer may be at a Walgreens store and desire to use a co-branded Walgreens®—Wells Fargo® Bank credit card. In both instances, a single issuer 710 provides all the portable payment devices of that type for the respective merchant. Therefore, the merchant 704 can make an inquiry of that issuer 710 via the payment processing system 700 to determine the account number for the particular consumer. To do so, the sales clerk operating the point of sale terminal 705 asks the consumer for specific biographical information, such as the consumer's name and drivers license number or social security number. At least one specific type of information that commonly would be known only by the particular consumer, e.g. the drivers license or social security number, is required to perform this function for security reasons. Merely asking for only the person's name, address, and telephone number does not guarantee that the consumer is actually the person who he or she claims to be. The sales clerk enters the consumer's biographical information and a designation for an account number inquiry into the keyboard 204 (FIG. 2) of the point of sale terminal 705. After all the required biographical information has been entered, the merchant 704 transmits an account number request 702 to the acquirer 706. That request is in the form of a message which has a format similar to that used with other types of non-financial data described previously, however this request message has a unique transaction identification code denoting an inquiry for an existing account number. The unique transaction identification code also denotes that there is not a corresponding message containing financial data. In other words, this is a single message transmission with only non-financial transaction data. The account number request 702 also contains an identifier of the merchant 704 and an identification of the type of card associated with the account number request, e.g. a privately branded Wal-mart® store credit card.

Alternatively, if a consumer's account is not associated with a particular merchant, i.e., is not a store payment card or a co-branded store card account available from only one issuer, but is a generic payment card account issued by any of hundreds of financial institutions, the merchant must also provide an identification of the specific issuer for that consumer. For example, the merchant may have to supply the name of the financial institution and possibly the city in which the main branch is located.

The acquirer 706 modifies the account number request 702 by adding an acquirer identifier to form a modified account number request 703. That modified 703 is sent by the acquirer 706 to the transaction expediter 708, such as Visa Inc. of San Francisco, Calif., USA. The transaction expediter 708 inspects the request to determine the identity of the issuer from which the account number is to be obtained. As noted, if the portable payment device is a privately branded store credit card or a co-branded payment card from a particular store and bank, the single issuer for that type of card is then known. For generic portable payment devices, the issuer identification information contained in the modified account number request is used by the transaction expediter 708 to determine how to route that request to that specified issuer 710. Once the identity of the issuer 710 has been determined, the transaction expediter 708 forwards the modified account number request 703 to the respective issuer 710.

Upon receipt of a modified account number request 703, the issuer 710 utilizes the consumer biographical information therein to access an account database and obtain the account number for that consumer. The issuer 710 then formulates a reply 712 identifying the consumer by name and containing the associated account number, e.g., the number of the credit card assigned to that consumer. The reply 712 also contains the merchant identifier and the acquirer identifier from the account number request. The reply 712 is sent to the transaction expediter 708 which uses the acquirer identifier therein to route the reply to that acquirer 706. Upon receiving the reply 712, the acquirer 706 uses the merchant identifier to forward the reply onward to that merchant 704.

When the merchant 704 receives the reply 712, the requested information is displayed on the point of sale terminal 705 for reading by the sales clerk. This request and reply of the account information occurs in real time while the consumer is present at the point of sale terminal. Thus upon receiving the reply, the sales clerk uses the payment account information to complete the sales transaction. The process then initiates another exchange of financial transaction data via the standard payment process as though the consumer had presented a portable payment device at the point of sale terminal 705.

With reference to FIG. 8, a merchant 804 is able to query the payment processing system 800 to determine a consumer's account balance both in terms of the amount of money owed and the balance of the credit limit that is available for use. This informational inquiry commences by entering the associated account number into a point of sale terminal 805. Then by additional entries into the point of sale terminal keyboard 204 (FIG. 2), the merchant 804 designates that an inquiry should be made to obtain the balances for that account.

Next, the merchant 804 formulates a request 802 containing a transaction identifier which designates this as a non-purchase account balance inquiry request, the consumer's account number, and an identifier of the merchant. The account balance request 802 is sent to the acquirer 806 associated with the merchant 804. The acquirer 806 modifies the message by adding its identifier before forwarding the modified account balance request 803 to the transaction expediter 808. Upon receipt, the transaction expediter 808 examines the incoming request to obtain the account number. As noted previously, a portion of the account number identifies the issuer 810 of that account. That issuer identification is used by the transaction expediter 808 to forward the account balance request 803 to the particular issuer 810.

The issuer 810, upon receiving the modified account balance request 803, determines from the transaction identifier that this is an account balance inquiry and utilizes the account number to obtain the financial information relating thereto. In the case of a credit card account, the issuer 810 determines the amount of unpaid charges in the account and the remaining amount of the credit limit that is available for further charges. If the account is a debit account or a prepaid account, the issuer 810 determines the amount of funds available in the account against which purchases may be made. The respective monetary values are then inserted into a reply 812 along with the identification of the consumer, the acquirer 806 and the merchant 804 from the request 803. The reply 812 is sent from the issuer 810 to the transaction expediter 808.

The transaction expediter 808 forwards the reply 812 to the identified acquirer 806, which obtains the merchant identifier from that message and continues to forward the reply 812 to the merchant 804 which originated the original request.

Upon receiving the reply 812, the merchant 804 displays the requested information on the point of sale terminal 805 for inspection by the sales person. This information may be told to the consumer or printed out at the point of sale terminal 805 for the consumer.

This account balance inquiry method also may be used by a merchant to obtain information about a prospective customer's account to determine whether that person has a sufficient amount of credit to make a purchase. This is particularly useful prior to large monetary value purchases.

In other situations a merchant may obtain preauthorization for a given amount of charges. For example, upon registering at a hotel, the innkeeper often obtains preauthorization from an issuer for a given amount of charges which are expected to be made against the consumer's payment account for the intended duration of a stay. For example, if the consumer is registering for three nights, the innkeeper will obtain preauthorization for the room charges and taxes for a three-night stay even though the charges for each night have not yet accrued. The preauthorization also may include nominal amounts for restaurant and other types of charges made by a typical hotel guest. The actual debiting of the amounts to the consumer's payment account does not occur until checkout, several days later. Nevertheless, the monetary amount of the preauthorization is in effect withdrawn from the amount of credit available to that consumer and reserved for use by the hotel. When the credit charge transaction is processed upon the consumer checking out of the hotel, the preauthorization is removed and the actual monetary amount of the products and services is debited to the consumer's account.

Another unrelated merchant can make a query of the issuer to determine whether other merchants have obtained preauthorizations which significantly encumber a consumer's ability to make a large purchase at the unrelated merchant. Information regarding the payment history of a particular consumer also can be obtained from an account issuer. These inquiries are useful in determining the credit risk that is presented by a given consumer and can be used by a merchant that is intending to extend its personal credit to the consumer.

With reference to FIG. 9, a merchant 904, seeking information about a consumer's preauthorization or payment history, enters the account number for the consumer into the point of sale terminal 905. In addition, the appropriate inquiry code for the preauthorization information is entered into the point of sale terminal. This causes the merchant 904 to formulate an inquiry in the form of an information request 902 that contains the account number, identification of the merchant 904, and a transaction identifier indicating the nature of this inquiry. The information request 902 is then forwarded to the acquirer 906 that modifies the message to incorporate the acquirer's identity. The modified information request 903 is sent through the transaction expediter 908 to the appropriate issuer 910. The issuer 910 responds to the information request by formulating the reply 912 containing the requested information regarding the specified account. The reply 912 is sent back through the transaction expediter 908 and acquirer 906 to the merchant 904. The information from the reply 912 is then displayed on the point of sale terminal 905 for observation by personnel at the merchant.

The enhanced payment processing system that allows the conveyance of non-purchase related data, can also be used to enable a merchant to conduct account administrative functions on behalf of a consumer. Such functions include processing an application for a new account, receiving payment for a balance on an account, and transferring balances between accounts, for example.

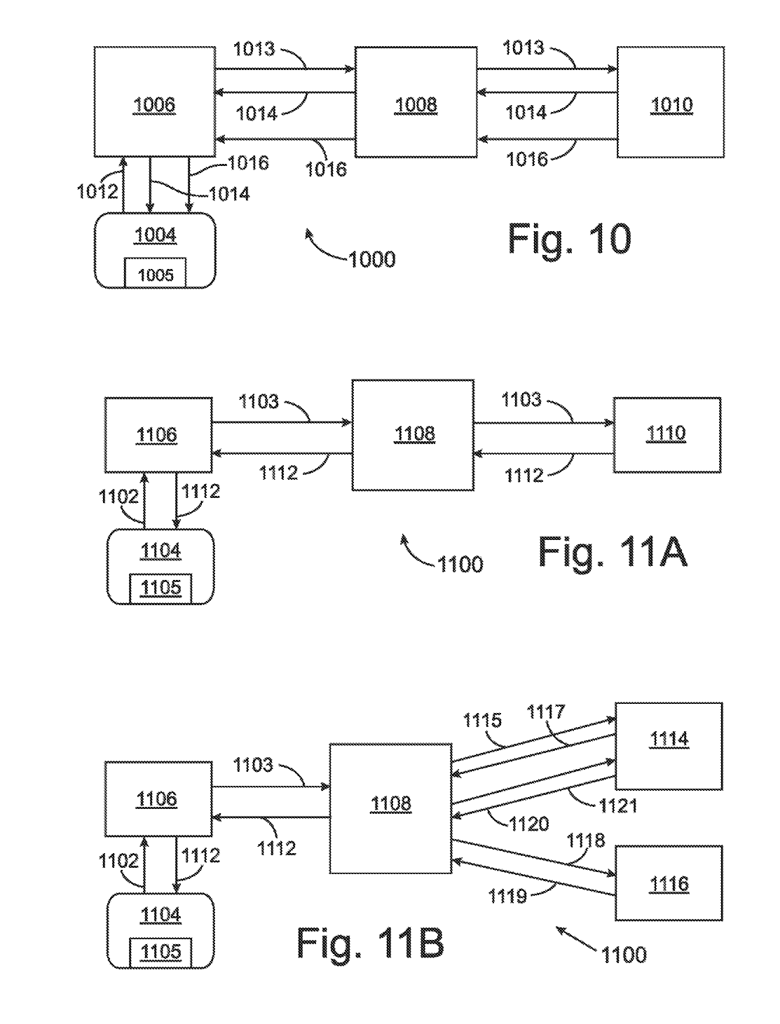

With respect to FIG. 10, the point of sale terminal 1005 at a merchant 1004 can be configured to accept information contained on a payment account application. That information is the same as requested on a paper credit account application form. To perform this function, a sales clerk at a point of sale terminal 1005 enters the appropriate function code into the terminal which causes a payment account application form to be presented on the display 206 (FIG. 2). That form is a template with blanks to be filled in with information provided by the consumer applicant. The sales clerk may orally ask the consumer for each item of information which the sales clerk types into the point of sale terminal, or the consumer may fill out a written form from which the sales clerk transfers the information into the point of sale terminal. After the required information has been inputted into the point of sale terminal 1005, the merchant 4004 creates an account application request 1012 which contains that information, a merchant identifier, and a transaction identifier designating an account application. The account application request 1012 is conveyed via the payment processing system 1000 to the acquirer 1006 associated with the merchant 1004.

The acquirer 1006, upon receiving the account application request 1012, inserts its identifier into the message, thereby forming a modified account application request 1013, which is transferred to the transaction expediter 1008. If the merchant 1004 is associated with a chain of stores having a co-branded portable payment device, such as a Walgreens®—Wells Fargo® Visa credit card associated with the Walgreens® pharmacy chain, the transaction expediter 1008 recognizes that this application is from a Walgreens store and directs the account application request 113 to the specific issuer 1010 for those co-branded cards. If there is no special card program associated with the merchant 1004 from which the account application originated, the transaction expediter 1008 uses other rules to determine to which issuer the application should be directed. For example, the address of the consumer in the application data or the designation of the merchant 1004 may be used to direct the modified account application request 1013 to an issuer 1010 for the corresponding geographical area.

Upon receiving the modified account application request 1013, the issuer 1010 immediately replies with a confirmation message 1014 that indicates the receipt of the account application. That confirmation message 1014 is sent through the transaction expediter 1008 and the acquirer 1006 to the merchant 1004 where it is displayed on the point of sale terminal 1005.

Immediately thereafter, the issuer 1010 begins processing the application by determining the credit worthiness of the consumer applicant. This process is similar to that conducted for conventional account applications and can be done electronically utilizing information from various credit reporting services and other sources available to the issuer. If the credit worthiness review indicates that the consumer applicant has a relatively high credit rating or an unacceptably low credit rating, as determined according rules established by the issuer 1010, a decision reply 1016 is sent automatically by the issuer's computer indicating acceptance or denial of the account application. A decision reply 1016 indicating issuance of an account contains the account number, the assigned credit limit, and the identity of the issuer. Identification of the acquirer 1006 and the merchant 1004 which processed the account application request 1013 also are incorporated into the decision reply. The decision reply 1016 is forwarded through the transaction expediter 1008 to the designated acquirer 1006 and then onward to the specified merchant 1004. The merchant 1004 prints out the decision at the point of sale terminal 1005. The approval process can occur in real time, while the consumer is at the point of sale terminal, thereby enabling a new account to be used immediately at the merchant 1004 for a purchase.

In other situations where the credit review for the consumer does not immediately indicate that the application can be approved or denied, but requires further analysis, the decision reply 1016 is not sent immediately. In that case, another reply message indicating that the application requires further review is transmitted by the issuer 1010 to the merchant 1004. This informs the consumer applicant not to wait at the merchant 1004 for the application decision. When that decision is ultimately made by the issuer 1010, a decision reply 1016 is sent as described previously to the merchant 1004 which then can inform the consumer applicant of the acceptance or denial of the account application. A document indicating the decision and other relevant information also is mailed to the consumer applicant.

An enhanced payment system also enables a merchant to initiate the transfer funds from one portable payment device account to another account. This is useful not only when closing out one account and opening a new one, but also to transfer a balance from a high interest bearing credit card account to one having a lower interest rate.

FIG. 11A, depicts this transfer process for a closed payment system in which both accounts were granted by the same issuer. The transfer is initiated by the consumer presenting the portable payment devices for the two accounts to a merchant 1104 and describing the nature of the transaction. An employee at the merchant 1104 then enters the account transfer function designation into the terminal into the point of sale terminal 1105. The point of sale terminal prompts the employee to scan the portable payment device from which the amount is to be transferred and then to scan the portable payment device for the account into which the amount is to be transferred. The entire balance of the first device's account can be transferred or only a specified amount as inputted into the point of sale terminal 1105.

Upon the completion of the data entry, the merchant 1104 formulates a transfer request 1102 indicating the two account numbers, the direction of the transfer, the amount of the transfer, and an identifier of the merchant. That transfer request 1102 is conveyed to the acquirer 1106 which modifies the request message by incorporating an identifier of the acquirer. The modified transfer request 1103 is sent to the transaction expediter 1108.

In this example both accounts have the same issuer 1110 which receives the modified transfer request 1103 from the transaction expediter 1108. The issuer 1110 responds by transferring the requested amount between the two accounts and sends a reply 1112 back through the payment processing system 1100 to the merchant 1104. This reply confirms that the transfer was made and enables the merchant 1104 to acknowledge that transaction to the customer who is still present at the point of sale terminal 1105.

In another situation, the two accounts involved in a balance transfer were provided by different issuers 1114 and 1116, as shown in FIG. 11B. In this situation, the formulation of the transfer request by the merchant 1104 is the same as described previously with respect to FIG. 11A. Now, however, upon receiving the modified account transfer request 1103, the transaction expediter 1108 exchanges a series of messages with the two issuers 1114 and 1116 to carry out the transfer. Assume that the first account having a current balance that is to be transferred was issued by a first issuer 1114 and the second account into which the account balance is to be transferred was issued by a second issuer 1116. In this instance, the transaction expediter 1108, upon inspecting the incoming modified account transfer request 1103, determines from the two account numbers that separate issuers are involved. Upon determining the account number from which the balance is to be transferred, the transaction expediter sends a first request 1115 asking the first issuer 1114 for the monetary amount of the balance in the first account. The first issuer 1114 responds by sending that monetary amount value to the transaction expediter 1108 in a first reply message 1117. If the modified account transfer request 1103 designated the monetary amount that is to be transferred, then messages 1115 and 1117 do not have to be exchanged.

Once the transaction expediter 1108 knows the monetary amount to be transferred, it sends the second issuer 1116 a debit request 1118 containing the second account number and the monetary amount to be transferred. The debit request 1118 is similar to a message that would be sent when a charge is made at the merchant in the amount of the transfer, however, the debit request designates that this is an account balance transfer transaction. The second issuer 1116 responds by debiting the designated account for the monetary amount and then sends a reply 1119 confirming compliance with the request. In rare cases, the second issuer 1116 may deny the debit request, such as if compliance would exceed the account limit, in which case the reply 1119 indicates denial of the debit request.

Assuming that the reply 1119 indicates compliance with the debit request, the transaction expediter 1108 now sends a credit request 1120 to the first issuer 1114 instructing that the first account be credited for the monetary amount. The credit request 1120 effectively makes a payment into the first account in the amount of the transfer. The first issuer 1114 responds by sending a credit reply 1121 to the transaction expediter 1108 indicating compliance with the credit request 1120.

Thereafter the transaction expediter 1108 sends a confirmation reply 1112 to the acquirer 1106 associated with the original request 1103 acknowledging that the monetary transfer has occurred. The acquirer 1106 forwards that composite reply 1112 to the merchant 1104. Subsequently, standard clearing and settlement operations are performed by the payment processing system 1100 to transfer the requisite funds between the first and second issuers 1114 and 1118.

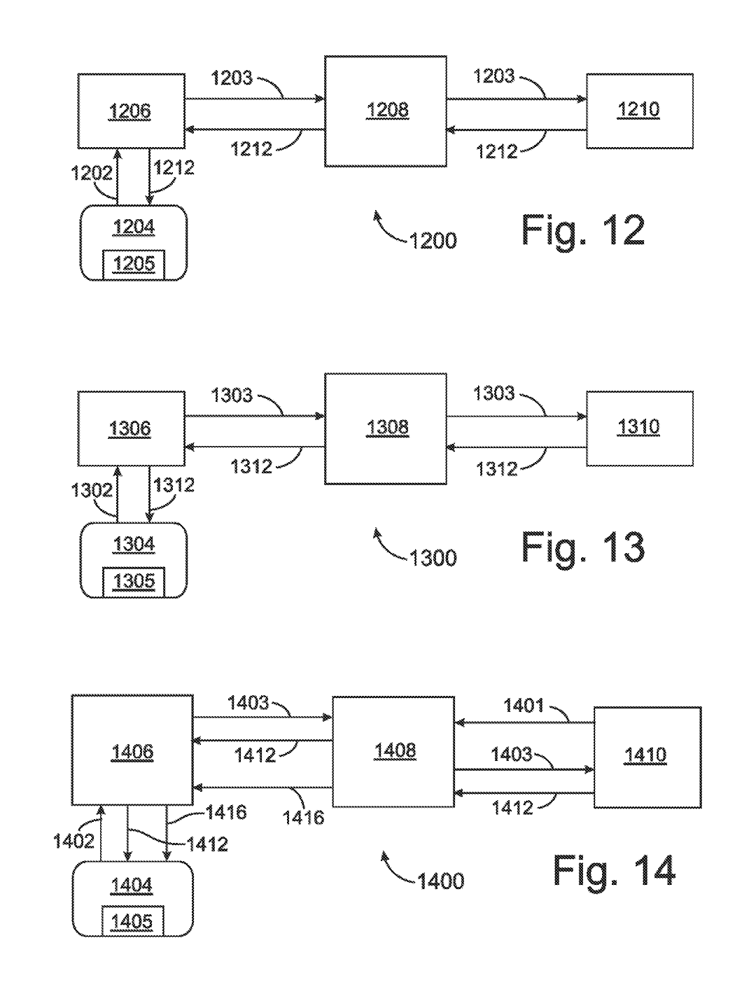

The enhanced payment processing system 1200 illustrated in FIG. 12 enables a merchant to receive a payment from a consumer which is applied toward the balance due on an account. Heretofore, such payments had to be made directly to the account issuer. In the enhanced system, the consumer can approach a merchant that is able to handle transactions with the associated portable payment device. The consumer delivers the payment to the merchant 1204 that then scans the consumer's portable payment device into the point of sale terminal 1205. However, instead of indicating a credit transaction, the merchant indicates that an account payment has been received. The merchant 1204 responds by formulating an account payment request 1202 that contains the account number from the portable payment device, an identification of the merchant 1204, the amount of the payment, and a transaction identifier indicating that this is an account payment. The account payment request 1202 is sent to the acquirer 1206 that adds its identifier to formulate a modified account payment request 1203. That modified request is then sent to the transaction expediter 1208. By inspecting the account number in the modified account payment request 1203, the transaction expediter 1208 determines which issuer 1210 is associated with that account and forwards the request to that issuer 1210.

Upon receipt of the modified account payment request 1203, the issuer 1210 credits the designated payment account for the specified amount. After that has occurred, the issuer 1210 formulates and sends a reply 1212 indicating that the payment has been properly credited and identifying the acquirer 1206 and the merchant 1204. That reply 1212 is forwarded through the transaction expediter 1208 and the acquirer 1206 to the merchant 1204. The merchant responds by the point of sale terminal 1205 printing a payment receipt for the consumer.

The next time that the payment processing system 1200 clears and settles transactions, a reverse settlement occurs. Specifically, the merchant's account is debited for the amount of the payment that was received and the issuer 1210 is credited for the payment amount.

With reference to FIG. 13, an enhanced payment processing system 1300 is shown for use in renewing an expiration date of a portable payment device. Many stores sell prepaid cards, often called gift cards, which can be used to pay for purchases of products and services at a specified merchant. Those cards are manufactured with an expiration date encoded in them, such as in the data written on a magnetic stripe. If the cards do not sell quickly enough, a given card may not have a sufficient amount of time remaining until its expiration date to allow a purchaser to use the card. In this instance, the point of sale terminal 1305 can be employed to request the issuer of the card to extend the expiration date. In a similar manner, a previously purchased prepaid card can be presented to a merchant by a consumer requesting that the expiration date be extended.

In either of those instances, the merchant 1304 scans the prepaid card and enters a function designation into the point of sale terminal 1305 indicating a desire to extend the card's expiration date. The merchant 1304 responds to the entry of that data by formulating an expiration extension request 1302 that includes the card's number and expiration date, along with a merchant identifier. That request 1302 is then sent by the merchant 1304 to its associated acquirer 1306. The acquirer 1306 modifies that request by adding its identification to the message thereby formulating a modified expiration extension request 1303. That modified request 1303 is conveyed to the transaction expediter 1308 which, based on the card number, determines the issuer of that card and forwards the request to that issuer 1310.

The issuer 1310 of the prepaid card responds to the modified expiration extension request 1303 by examining the present expiration date in comparison to the date on which the expiration extension request is received. This enables the issuer to determine whether an extension should be granted and if so, a new expiration date. Alternatively the merchant can propose a new expiration data in the expiration extension request 1302, which proposal may or may not be accepted by the issuer 1310. Any a new expiration date is recorded for that card number at the issuer and is transmitted in a reply 1312 which contains the identifiers of both the acquirer 1306 and the merchant 1304. The reply 1312 is sent back through the payment processing system 1300 via the transaction expediter 1308 and the acquirer 1306 to the merchant 1304. The new expiration date is displayed on the merchant's point of sale terminal 1305 along with instruction to swipe the prepaid card through the point of sale terminal again. This allows the new expiration date to be recorded on the magnetic stripe of the card. Thus, the enhanced payment processing system 1300 provides a mechanism by which the expiration date of a portable payment device can be extended.

With reference to FIG. 14, an enhanced payment processing system 1400 also can be utilized to restrict the use of a portable payment device to particular merchants, a geographical territory, types of products and services, and the nature of the transaction. This feature is referred to as a “limited acceptance function.” Previously, use of a portable payment device had been limited by a monetary amount, such as a credit limit, an amount in a debit account, or the unused balance on a prepaid device. Another previous restriction was temporal and related to an expiration date for the portable payment device. In contrast the restrictions of the present limited acceptance function are non-monetary and non-temporal.

The issuer 1410 of a portable payment device limits the use of that device by defining a set of restrictions which are communicated to the transaction expediter 1408 as a restriction message 1401. The restriction message identifies the account number of the portable payment device, one or more types of restriction, and a parameter for each specified restriction type. For example, parameters for a geographical or jurisdictional restriction specify one or more countries or governmental subdivisions of a country. A merchant commodity code restriction limits purchases made with the portable payment device to certain types of goods or services, such as those which are health related, for example. A transaction type restriction can limit the device usage to only payments for products and services thereby excluding automated teller machine (ATM) transactions, for example. A merchant restriction type regulates the use of the portable payment device to one or more specific merchants or store chains. A channel restriction can limit the usage to face to face transactions where the device holder must be at the merchant, transactions requiring the device be presented to the merchant, or electronic commerce transactions. Upon receiving the restriction message 1401, the transaction expediter 1408 stores the restrictions in a database that is organized by account number.

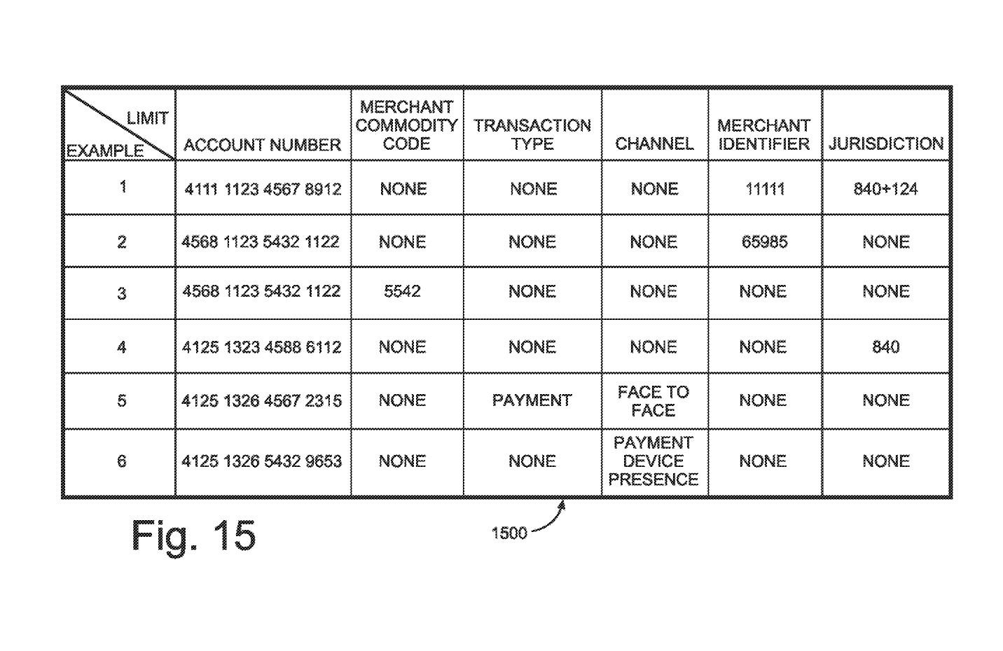

The table in FIG. 15 represents information in that restriction database 1500 for several exemplary accounts. Example 1 depicts data for a privately branded store credit card in which the second through sixth digits (11111) of the account number identify the particular store, as well as the issuer financial institution. The merchant identifier field of the restrictions contains those digits, thereby denoting that account use is limited to the associated store or chain of stores. In this example, use of the portable payment device for this account also is restricted to merchants located in the United States and Canada as indicated by the jurisdiction field containing the restriction parameters “840+124”, i.e., numerical codes for those countries.

In example 2, a portable payment device from an issuer which is not affiliated with a particular store or chain of stores is limited to use at a particular merchant. For instance, the transaction expediter 1408, such as Visa, Inc., may provide a class of portable payment devices which are commonly referred to as a “purchase card”. The device holder may be a business which gives the purchase card to an employee in order to make purchases at a specific store or chain of stores. For illustration, a purchase card is provided so that an office manager can purchase products at a Staples® office supply store, because the business has negotiated a price discount with the Staples® store chain. Therefore, that generic Visa brand payment card cannot be used for other types of goods or services or even at other office supply stores. In example 2, the merchant identifier field in the restriction database 1500 for that card account number has a numeric code “65985” designating the Staples® office supply store chain.

Alternatively, in example 3, the purchase card could allow the office manager to purchase supplies at any office supply store. In this case, the merchant commodity code field of the restriction database contains a code “5542” designating office supplies, thereby allowing the office manager to purchase those types of products at any store associated with that merchant commodity code. The merchant commodity code is an existing four-digit code that is assigned to every merchant that accepts a particular type of portable payment device, such as a Visa brand credit card, and identifies the products and/or services that the supplier provides. Other forms of identifiers for types of products and services could also be used in stead of the standard merchant commodity code.

The portable payment device account in example 4 is restricted to use in a particular country, in this case, the United States as designated by jurisdiction code “840”. The associated portable payment device can be used for any type of transaction at any merchant which accepts that type of payment device provided that the merchant is in the United States.

Example 5 indicates the data in the restriction database that limits use of the associated portable payment device to face-to-face transactions, where the cardholder is present at the merchant and to only payments for goods and services. The face-to-face nature of a given transaction is indicated by a channel code sent by the merchant with a payment authorization request. If the transaction was via the telephone or an online transaction, other channel codes would be used in the payment authorization request.

Example 6 shows setup for restricting use of a portable payment device to only those transactions where the portable payment device is present. This is similar to a face-to-face transaction, however it excludes transactions where the cardholder may be present at the merchant but reads the account number or for which the merchant queries the issuer for the consumer's account number, as described previously with respect to FIG. 9.

The restriction database 1500 is used subsequently, when a consumer makes a transaction with a portable payment device. At that time, the merchant 1404 enters the transaction into the point of sale terminal 1405 in a conventional manner and a payment authorization request 1402 is transmitted to the acquirer 1406. The acquirer 1406 modifies the request to incorporate the acquirer's identity and sends a modified payment authorization request 1403 to the transaction expediter 1408.

The transaction expediter 1408 extracts the account number from the request 1403 and queries the restriction database 1500 to determine any limits that have been placed on use of that account and the associated portable payment device. If a restriction is not found in the database 1500, the transaction expediter 1408 forwards the modified payment authorization request 1403 to the issuer 1410 as was done prior to implementation of the limited acceptance function. The issuer 1410 approves or denies the payment authorization request and sends an appropriate reply 1412 through the enhanced payment processing system 1400 to the merchant 1404.

If a restriction is found in the database 1500, the transaction expediter 1408 responds to the nature of that restriction. If a merchant commodity code limitation exists the transaction expediter 1408 compares that code with the merchant commodity code for the merchant 1404 that issued the payment authorization request 1402. The merchant commodity code for each merchant may be transmitted as part of the request or stored in another database at the transaction expediter 1408. For other limitations in the restriction database 1500, the parameter for a defined limitation is compared to data in the modified payment authorization request 1403, such as for the merchant identifier, the merchant's jurisdiction, etc. If the modified payment authorization request 1403 complies with the limitations in the restriction database 1500, the transaction expediter 1408 forwards the modified payment authorization request 1403 to the issuer 1410. Otherwise the transaction expediter 1408 sends a reply 1416 to the merchant 1404 denying the payment authorization request.

The steps of a method, process, or algorithm described in connection with the implementations disclosed herein may be embodied directly in hardware executing software, in a software module executed by hardware, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed implementations is provided to enable any person of ordinary skill in the art to make or use the disclosure. Various modifications to these implementations will be readily apparent to those of ordinary skill in the art, and the generic principles defined herein may be applied to other implementations without departing from the spirit or scope of the disclosure. Thus, the disclosure is not intended to be limited to the implementations shown herein but is to be accorded the widest scope consistent with the principles and novel features disclosed herein.

We claim:

1. In a payment processing system in which a transaction expediter processes a plurality of sales transactions, each characterized by a consumer and a merchant engaging in a sales transaction upon an account that was provided to the consumer by an issuer, a method comprising a plurality of steps each being performed by hardware executing software, wherein the steps include:
formulating a non-sales related request;
conveying the non-sales related request through the payment processing system to a recipient; and
conveying a reply to the non-sales related request from the recipient through the payment processing system to an entity that formulated the non-sales related request.

2. The method as recited in claim 1, wherein the non-sales related request is an application from a consumer for an account.

3. The method as recited in claim 1, wherein the non-sales related request identifies a consumer and asks that an entity that formulated the non-sales related request be sent an identification of the account that previously was assigned to the consumer.

4. The method as recited in claim 1, wherein the non-sales related request specifies a transfer of a monetary amount from a first account within the payment processing system to a second account.

5. The method as recited in claim 4, wherein the first account and the second account are provided by a single issuer.

6. The method as recited in claim 4, wherein the first account is provided by a first issuer and the second account is provided by a second issuer.

7. The method as recited in claim 6, wherein the transaction expediter sends a message to the second issuer instructing that the monetary amount be debited to the second account, and sends another message to the first issuer instructing that the monetary amount be credited to the first account.

8. The method as recited in claim 7, wherein the transaction expediter sends the message to the first issuer after receiving a reply from the second issuer which acknowledges debiting the second account.

9. The method as recited in claim 1, wherein a merchant receives a payment to be applied to an account issued by an issuer, and the non-sales related request specifies an amount of money that is to be credited to that account.

10. The method as recited in claim 1, wherein the non-sales related request requests that an expiration date of a portable payment device be extended.

11. The method as recited in claim 10, wherein the reply indicates a new expiration date; and further comprising the merchant recording the new expiration date on the portable payment device.

12. In a payment processing system in which a transaction expediter processes a plurality of sales transactions, each characterized by a consumer and a merchant engaging in a sales transaction upon an account provided to the consumer by an issuer, a method comprising a plurality of steps each being performed by hardware executing software, wherein the steps include:
an issuer receiving a non-sales related request that was sent by a merchant through the payment processing system;
the issuer performing acts in response to the non-sales related request;
the issuer formulating a reply related to the acts; and
the issuer sending the reply through the payment processing system.

13. The method as recited in claim 12, wherein the non-sales related request pertains to one of an application from a consumer for an account, a request for identification of an account assigned to a designated consumer, transferring a monetary amount between first and second accounts, a payment to be applied to an account, and changing an expiration date of a portable payment device.

14. The method as recited in claim 12, wherein the non-sales related request pertains to an application from a consumer for an account, and the reply indicates acceptance or denial of the application by the issuer.

15. The method as recited in claim 12, wherein the non-sales related request pertains to changing an expiration date for a portable payment device, and the reply indicates a new expiration date.

16. A computer readable medium comprising the software for the execution by the hardware to perform the steps recited in the method of claim 12.

17. In a payment processing system in which a transaction expediter processes a plurality of sales transactions each characterized by a consumer and a merchant engaging in a sales transaction upon an account within the payment processing system, wherein an issuer has provided the account to the consumer, a method comprising a plurality of steps each being performed by hardware executing software, wherein the steps include:
defining at least one restriction to be applied to transactions involving a given account, wherein the at least one restriction is non-monetary and non-temporal;
for a given transaction involving the given account, determining whether the given transaction conforms with each restriction; and
if the given transaction conforms with every restriction, approving the given transaction.

18. The method as recited in claim 17, wherein if the given transaction fails to conform with every restriction, rejecting the given transaction.

19. The method as recited in claim 17, wherein the at least one restriction limits use of the given account to one of a particular merchant, a group of merchants, a geographical territory, and a type of products and services.

20. The method as recited in claim 17, wherein the at least one restriction limits use of the given account to payment for products and/or services.

21. The method as recited in claim 17, wherein the at least one restriction limits use of the given account to one of or a combination of face-to-face transactions, electronic commerce transactions, transactions in which a portable payment device is shown to the merchant, and telephonic transactions.

22. A computer readable medium comprising the software for the execution by the hardware to perform the steps recited in the method of claim 17.
